(19) United States
(12) Patent Application Publication
(10) Pub. No.: US 2023/0302426 A1
(43) Pub. Date: Sep. 28, 2023

(54) Reactor and Method for Carrying Out a Chemical Reaction

(71) Applicants: LINDE GMBH, Pullach (DE); BASF SE, Ludwigshafen (DE)

(72) Inventors: Mathieu Zellhuber, Martinsried (DE); Martin Hofstatter, Munchen (DE); Heinz Posselt, Bad Aibling (DE); Christian Lang, Munchen (DE); Clara Delhomme-Neudecker, Munchen (DE)

(21) Appl. No.: 17/929,009

(22) PCT Filed: Feb. 9, 2021
(86) PCT No.: PCT/EP2021/053094

§ 371 Date: Jan. 10, 2023

(30) Foreign Application Priority Data
Feb. 10, 2020 (EP) 20156463.0

(51) Int. Cl. B01J 19/24; B01J 19/00

(52) U.S. Cl. CPC B01J 19/2425; B01J 19/0013; B01J 2219/00135; B01J 2219/2435

(57) ABSTRACT

Disclosed is a reactor for carrying out a chemical reaction and a corresponding method. The reactor includes a vessel and one or more reaction tubes where a number of tube sections of the reaction tubes run between first second regions in the reactor vessel, and where the tube sections in the first region for the electrical heating of the tube sections can be electrically connected to the phase connections of a polyphase AC power source. Tube sections in the second region are electrically and conductively connected to one another as a whole by means of a single rigid connecting element, or in groups by means of a plurality of rigid connecting elements which are integrally connected to the reaction tubes and are arranged inside the reactor vessel. A corresponding method is also the subject-matter of the present invention.

### CROSS-REFERENCE TO RELATED APPLICATIONS

This application is the national phase of, and claims priority to, International Application No. PCT/EP2021/053094, filed Feb. 9, 2021, which claims priority to European Patent Application No. 20156463.0, filed Feb. 10, 2020.

### BACKGROUND

### 1. Field

The disclosed embodiments relate to a reactor and a method for carrying out a chemical reaction according to the preambles of the independent claims.

### 2. Description of the Related Art

In a number of processes in the chemical industry, reactors are used in which one or more reactants are passed through heated reaction tubes and catalytically or non-catalytically reacted there. The heating serves in particular to overcome the activation energy required for the chemical reaction that is taking place. The reaction can proceed as a whole endothermically or, after overcoming the activation energy, exothermically. The disclosed embodiments relate in particular to strongly endothermic reactions.

Examples of such processes are steam cracking, various reforming processes, in particular steam reforming, dry reforming (carbon dioxide reforming), mixed reforming processes, processes for dehydrogenating alkanes, and the like. During steam cracking, the reaction tubes are routed through the reactor in the form of coils which can have a reversal point in the reactor, whereas tubes running through the reactor without a reversal point are typically used in steam reforming.

The disclosed embodiments are is suitable for all such processes and designs of reaction tubes. The articles “Ethylene,” “Gas production,” and “Propene” in Ullmann's Encyclopedia of Industrial Chemistry, for example the publications dated Apr. 15, 2009, DOI: 10.1002/14356007.a10_045.pub2, dated Dec. 15, 2006, DOI: 10.1002/14356007.a12_169.pub2, and dated Jun. 15, 2000, DOI: 10.1002/14356007.a22_211, are referred to here for purely illustrative purposes.

The reaction tubes of corresponding reactors are conventionally heated using burners. In this case, the reaction tubes are routed through a combustion chamber in which the burners are also arranged.

However, as described, for example, in DE 10 2015 004 121 A1 (likewise EP 3 075 704 A1), the demand for synthesis gas and hydrogen which are produced with or without reduced local carbon dioxide emissions is, for example, currently increasing. However, this demand cannot be met by processes in which fired reactors are used due to the combustion of typically fossil energy carriers. Other processes are ruled out, for example, due to high costs. The same also applies to the provision of olefins and/or other hydrocarbons by steam cracking or the dehydrogenation of alkanes. In such cases, too, there is a desire for processes that at least on site emit lower amounts of carbon dioxide.

Against this background, the aforementioned DE 10 2015 004 121 A1 proposes an electrical heating of a reactor for steam reforming in addition to a firing. In this case, one or more voltage sources are used which provide a three-phase alternating voltage on three external conductors. Each external conductor is connected to a reaction tube. A star circuit is formed in which a star point is realized by a collector into which the pipelines open and to which the reaction tubes are conductively connected. In this way, the collector ideally remains potential-free. In relation to the vertical, the collector is arranged below and outside the combustion chamber and preferably extends transversely to the reactor tubes or along the horizontal.

A corresponding electrical heating of a reactor can be problematic in cases in which no collector of the type explained is present, e.g., in reactors in which the reaction tubes have, within the reactor, a reversal point at which they are to be connected to the star point, as is also the case, for example, in WO 2015/197181 A1. Due to the high current flows and temperatures in the reactor, it is difficult to find a solution for electrically connecting the reactor tubes at the star point with satisfactory current transition values in order to reduce excessive power losses and to ensure that current flow is uniformly distributed and the star point is thus potential-free.

US 2014/02338523 A1 relates to a device for heating a pipeline system for a molten salt, comprising at least two pipelines along which an electrical resistance heating element extends, wherein a potential close to ground potential is set at least one end at each electrical resistance heating element, and the electrical resistance heating element is connected remotely therefrom to a connection of a direct current source or in each case to a phase of an n-phase alternating current source.

WO 2015/069762 A2 discloses a chemical reactor system comprising a chemical reactor having an inlet and a manifold in fluidic connection with the inlet, the manifold comprising a manifold housing, the manifold housing defining a manifold chamber and having at least one additional component that may comprise a heater in thermal connection with the manifold chamber and a cavity, wherein the manifold housing defines the cavity and a seal is provided in a specific arrangement.

A fixed-bed reactor disclosed in US 2015/010467 A1 has an inflow path for raw gas for a catalytic reaction and an outflow path for reformed gas, a catalytic reaction vessel which is connected to the inflow path and the outflow path and contains a catalyst, catalyst holders which have a ventilation property and hold the catalyst, and a drive mechanism which moves the catalyst up and down by moving the catalyst holders up and down.

U.S. Pat. No. 6,296,814 B1 discloses a fuel reformer which serves to produce a hydrogen-enriched process fuel from a raw fuel. The catalyst tube arrangement preferably comprises a plurality of catalyst tubes which are arranged in a hexagonal arrangement. A housing contains internal hexagonal thermal insulation in order to ensure uniform heating of the catalyst tubes. The diameter of the tubes is dimensioned such that the distances between adjacent tubes in the arrangement can be minimized for efficient heat transfer.

### SUMMARY

In embodiments, a reactor and a related method for carrying out a chemical reaction is disclosed. The reactor, in embodiments, is provided for carrying out a chemical reaction. The reactor may include a reactor vessel and one or more reaction tubes, wherein a number of tube sections of the one or more reaction tubes run between a first region for electrical heating and a second region within the reactor vessel, and wherein the tube sections in the first region are electrically connected to the phase connections of a polyphase alternating current source, and used as electrical resistors in order to generate heat and; the tube sections in the second region are either: (i) electrically conductively connected to one another as a whole by means of a single rigid connecting element or in groups by means of a plurality of rigid connecting elements, which are integrally connected to the one or more reaction tubes; or, (ii) are arranged within the reactor vessel as one or more star bridges effecting a potential equalization, wherein the one or more connecting elements is or are configured for operation at a temperature of more than 700° C.

### DETAILED DESCRIPTION

In the mostly partially electrified furnace concept (the term “furnace” is commonly understood to denote a corresponding reactor or at least its thermally insulated reaction space) which is the basis of the disclosed embodiments, at least one of the reaction tubes or corresponding tube sections thereof (hereinafter also referred to for short as “tubes”) is itself used as electrical resistors in order to generate heat. This approach has the advantage of a greater efficiency compared to indirect heating by external electric heating elements as well as a higher attainable heat flux density. The disclosed embodiments include the possibility of also providing part of the total heating output in the furnace by firing other energy carriers, e.g., fossil energy carriers, such as natural gas, or even energy carriers such as so-called bio natural gas or biomethane.

If, therefore, electrical heating is mentioned here, it does not preclude the presence of additional non-electrical heating. In particular, it can also be provided that the contributions of electrical and non-electrical heating are varied over time, e.g., as a function of the supply and price of electricity or the supply and price of non-electrical energy carriers as mentioned above.

The current is fed into the directly heated reaction tubes via M separately connected phases. The current-conducting reaction tubes connected to the M phases must also be electrically connected to a star point. The number of phases M is in particular 3, corresponding to the number of phases of conventional three-phase current sources or networks. In principle, however, the disclosed embodiments are not restricted to the use of three phases but can also be used with a larger number of phases, e.g., a number of phases of 4, 5, 6, 7, or 8. A multiple of 3, e.g., 6, 9, 12 etc. is particularly preferred. A phase offset in this case is in particular 360°/M, i.e., 120° in the case of a three-phase current.

Potential equalization between the phases is achieved by the star circuit at the star point, which makes electrical insulation of the connected pipelines superfluous. This represents a particular advantage of such a furnace concept, since a break in the metallic reaction tubes for insulating certain sections is undesirable, in particular because of the high temperatures used and the high material and construction outlay thus required.

In the language of the claims, the disclosed embodiments relate to a reactor for carrying out a chemical reaction, which reactor has a reactor vessel (i.e., a thermally insulated or at least partially insulated region) and one or more reaction tubes, wherein a number of tube sections of the one or more reaction tubes in each case runs between a first region and a second region within the reactor vessel and through an intermediate region between the first and second regions, and wherein for the electrical heating of the tube sections, the tube sections are or can in each case be electrically connected in the first region to the phase connections (“external conductors”) of a polyphase alternating current source, for example, by means of busbars and connecting strips. Switching devices can be installed in particular on a primary side of an employed transformer system since there is a higher voltage and a lower current there.

As mentioned, an alternating voltage is in each case provided via the phase connections and the alternating voltages of the phase connections are phase-shifted in the manner explained above. Within the scope of the disclosed embodiments, for example, a supply network or a suitable generator and/or transformer can serve as an AC power source. The tube sections form a star circuit in which they are electrically conductively coupled to one another at their respective opposite end to the current supply, i.e., in the second region.

In the intermediate region, the tube sections run through the reactor vessel in particular freely, i.e. without mechanical support, without electrical contacting, and/or without fluidic or purely mechanical cross-connections to one another. They in particular run substantially or entirely straight in the intermediate region, wherein “substantially straight” is to be understood as meaning that an angular deviation of less than 10° or 5° is present.

According to the disclosed embodiments, the tube sections are electrically conductively connected to one another overall in the second region by means of a single rigid connecting element (“star bridge”) which is integrally connected to the one or more reaction tubes and is arranged inside the reactor vessel, or this connection is effected in groups by means of a plurality of such rigid connecting elements. The one or more connecting elements fluidically couple the respective electrically connected tube sections to each other at most in pairs. In this case, “at most in pairs” is to be understood as meaning that at most one tube section entering the connecting element is fluidically coupled to at most one other tube section entering the connecting element (or in the sense of the direction of flow, exiting therefrom) or that, in other words, the tube sections in each case fluidically connected in pairs via the connecting element in each case carry or are designed to carry substantially the same quantities of fluid per time unit. In this specific context, “substantially the same quantities of fluid” should be understood to mean a difference of not more than 10%, 5%, or 1%. The one or more connecting elements therefore couple the connected tube sections in a non-collecting and non-distributing manner, in contrast to a collector known from the prior art and arranged outside the reactor.

This measure proposed according to the disclosed embodiments has the advantage that a maximum potential equalization can take place via one or more star bridges formed by one or more connecting elements. This results in almost complete freedom from potential or a significantly reduced current return via a neutral conductor which may be connected thereto. The result is minimal current dissipation via the header connections to other parts of the process system and a high level of shock protection.

A further advantage of the one or more connecting elements proposed according to the disclosed embodiments in comparison to one or more collectors which is or are arranged outside the reactor vessel and optionally likewise provides or provide an electrical connection at a star point, consists in a more clearly defined distance of the electrical heat input (e.g., over all tube sections, which is not the case with a star point on a collector because electrically heated tube sections must here be guided from the warmer interior space to the colder exterior space) and spatially very homogeneous external thermal boundary conditions of the electrically heated tube sections (no electrical heating in the thermally insulated passages through the reactor vessel to the collector operated at low temperature). This results in process engineering advantages, for example, an expected excessive coke formation in heated and externally thermally insulated passages can be avoided.

Since the underlying reactions require high temperatures, the electrical connection in the second region must be realized in a high-temperature range of, for example, approximately 900° C. for steam cracking. This is possible through the measures proposed according to the disclosed embodiments by the selection of suitable materials. At the same time, the connection is intended to have a high electrical conductivity and high mechanical stability and reliability at high temperatures. Failure of the electrical connection directly prevents potential equalization and consequently leads to an instantaneous safety-related shutdown of the system due to undesired current flow in system parts. The disclosed embodiments provide advantages over the prior art by avoiding such situations.

In conventional burner-heated reaction tubes for steam cracking, there is no need for a connection between the U-bends of the reaction tubes arranged in the reactor, which here are suspended with a certain freedom of movement. In particular, the lower U-bends can hang freely in the reactor vessel, while the upper ones have less, but nevertheless some, freedom of movement. The freedom of movement is advantageous for the mechanical behavior of the reaction tubes, this being dominated primarily by the thermal expansion of the tubes. The disclosed embodiments are based accordingly on the finding that a rigid connection, which is considered negative in the context mentioned, offers advantages which outweigh the possible disadvantages of a lack of freedom of movement.

In the realization of a star circuit of reaction tubes, it is necessary to provide a construction which provides an adequately dimensioned electrically conductive cross-connection between the tube sections and at the same time which withstands the stresses resulting primarily from the high thermal expansion rates.

According to the prior art, it has not been as yet possible for the required electrical connection between the U-bends (star bridge) to be flexibly embodied in this temperature range. There are no materials with sufficient long-term temperature stability or sufficient processability (e.g., weldable) from which flexible electrical connections can be made. Moreover, there is hardly any connection technology available in this field of application for the metal-to-metal transition.

The disclosed embodiments are based accordingly on the surprising finding that, despite a lack of freedom of movement, a rigid star bridge connection which has a cross-section sufficient for the required electrical potential equalization is capable of absorbing the mechanical stresses occurring in high-temperature use over the operating times relevant to practical application. The currents flowing here lie in the kiloampere range and therefore require considerable design effort.

The disclosed embodiments will be described below first with reference to reaction tubes and reactors as used for steam cracking. However, as explained afterwards, the disclosed embodiments can also be used in other types of reactors, as subsequently mentioned. In general, as mentioned, the reactor proposed according to the disclosed embodiments can be used for carrying out any endothermic chemical reaction.

In a first development of the disclosed embodiments, the reactor can be used in particular with so-called 2-passage coils. These have two tube sections in the reactor vessel, which pass into one another via (exactly) one U-bend and therefore basically have the shape of an (elongated) U. The sections entering and exiting the reactor vessel, which in particular pass seamlessly or without a flow-relevant transition into the heated tube sections, are here referred to (also with reference to the reaction tubes described below) as “feed section” and “extraction section”. There is always a plurality of such reaction tubes present.

In this development, the reactor can therefore be designed in such a way that the tube sections each comprise two tube sections of a plurality of reaction tubes which are arranged at least partially side by side in the reactor vessel, the two tube sections of the multiple reaction tubes in each case passing into each other in the first region in each case via a U-bend. In particular, as mentioned, one of the in each case two tube sections in the second region is connected to a feed section and the others of the in each case two tube sections in the second section are connected to an extraction section.

In the development of the disclosed embodiment just explained, it can be provided in one variant that the one tube section of each of the two tube sections of the multiple reaction tubes in the second region is connected to a first one of the connecting elements and the other tube section of the respective two tube sections of the multiple reaction tubes in the second region is connected to a second one of the connecting elements. In this way, a plurality of in each case potential-free star points can be formed, with the advantage that, due to increased flexibility of narrower, multiple connecting elements, smaller mechanical stresses occur, in particular due to thermal expansions.

In the development of the disclosed embodiment just explained, in another variant it can in contrast be provided that in each case both tube sections of the multiple reaction tubes, and in particular all tube sections in the second region, are connected to a common connecting element. In this way, a potential-free star point is formed overall, with the advantage that, for example, a further intermediate connection can be dispensed with.

The development of the disclosed embodiment just explained can also be transferred to cases in which reaction tubes having two feed sections and one extraction section are used. In such reaction tubes, the two feed sections are in each case connected to one tube section. The extraction section is also connected to a tube section. The tube sections connected to the feed sections pass into the tube section connected to the extraction section in a typically Y-shaped connection area. Not only the tube sections connected to the feed sections but also the U-bend connected to the extraction section can each have one or more U-bends or none at all.

For example, reaction tubes as illustrated in FIG. 10C can be used. In these, the tube sections connected to the feed sections have no U-bend, whereas the tube section connected to the extraction section has a U-bend.

In this case, in particular tube sections, which are each formed by the tube sections connected to the feed sections, can be connected in the second region to a first one of the connecting elements and a tube section which is formed by the tube section connected to the extraction section is connected to a second one of the connecting elements. In this way, a plurality of respectively potential-free star points can be formed as above with the advantages likewise already explained above.

Alternatively, however, it can also be provided here in another variant that the tube sections, which are each formed by the tube sections connected to the feed sections, and the tube section, which is formed by the tube section connected to the extraction section, and in particular all tube sections in the second zone, are connected to a common connecting element. In this way, a potential-free star point is also formed overall here, with the advantage that, for example, a further intermediate connection can be dispensed with.

However, reaction tubes as illustrated in FIG. 10B may also be used. In these, the tube sections connected to the feed sections each have a U-bend and the tube section connected to the extraction section has two U-bends.

Even the use of reaction tubes as illustrated in FIG. 10A is possible. In these, the tube sections connected to the feed sections each have three U-bends and the tube section connected to the extraction section has two U-bends.

In the last two cases, any of the tube sections in the second region can also be connected to different connecting elements or to a common connecting element, as a result of which the advantages already explained above can likewise be achieved. A multiplicity of further configurations with branched or Y-shaped combined reaction tubes is also possible.

Alternatively, however, it can also be provided here in another variant that the tube sections, which are each formed by the tube sections connected to the feed sections, and the tube section, which is formed by the tube section connected to the extraction section, and in particular all tube sections in the second zone, are connected to a common connecting element. In this way, a potential-free star point is also formed overall here, with the advantage that, for example, a further intermediate connection can be dispensed with.

In addition to the development described above in particular with reference to 2-passage coils, however, a development suitable for use with so-called 4-passage coils can also be used. These have four essentially straight tube sections. However, arrangements with a higher, even number of straight tube sections are also possible.

In more general terms, a correspondingly designed reactor comprises one or more reaction tubes, each of which has an even number of four or more tube sections connected in series with one another via a number of U-bends, the number of U-bends being one less than the number of tube sections connected in series with one another via the U-bends, and wherein the U-bends are arranged alternately in the first and the second regions starting with a first U-bend in the first region.

A “U-bend” is understood here in particular to mean a tube section or pipe component which comprises a part-circular or part-elliptical, in particular a semicircular or semi-elliptical pipe bend. The beginning and end have cut surfaces lying next to one another in particular in one plane.

In a first example, in which a 4-passage coil is used, the tube sections mentioned include a first, a second, a third and a fourth tube section of a reaction tube or in each case of one reaction tube of several reaction tubes, wherein the first tube section passes via a first U-bend into the second tube section, the second tube section passes via a second U-bend into the third tube section and the third tube section passes via a third U-bend into the fourth tube section. The first tube section is in particular connected in the second zone to a feed section and the fourth tube section is in particular connected in the second zone to an extraction section. The first and third curved sections are arranged in the first region and the second curved section is arranged in the second region. These explanations correspondingly also apply to six tube sections, wherein a first, third and fifth curved section are then arranged in the first region and a second and fourth curved section are arranged in the second region.

In the developments just explained with one or more U-bends, the U-bends arranged in the second region can be formed in the connecting element and the tube sections can extend from the connecting element in the first region to the second region.

In this case, the connecting element can here be cast onto the formed tube sections previously joined to the U-bend(s) in the second region (for example, welded thereto) or connected to it or them (for example, by bending). In other words, a reaction tube can thus be formed beforehand with corresponding tube sections and one or more U-bends and then encapsulated in corresponding regions. This results in a simpler design of the reaction tubes.

Alternatively, however, it is also possible to form (for example, to cast) the U-bend(s) in the second region within the connecting element and to weld the tube sections to the connecting element. In this way, a corresponding reactor can be produced in a simplified and modular manner, and only the straight tube sections need be welded on. The use of the connecting element as a standard part results in lower production costs.

To summarize once again, a corresponding reactor can have any reaction tubes known from the prior art, such as are also described in particular in the above-mentioned article “Ethylene” in Ullmann's Encyclopedia of Industrial Chemistry. Corresponding reaction tubes are designated, for example, by SC-1, SC-2, SC-4, USC-U, Super U, USC-W, FFS, GK-1, GK-6, SMK, Pyrocrack 1-1, Pyrocrack 2-2 or Pyrocrack 4-2.

As mentioned, a corresponding reactor can be designed in particular as a reactor for steam cracking, that is in particular by the choice of temperature-resistant materials and the geometric configuration of the reaction tubes.

In a further alternative, however, the tube sections can each comprise a tube section consisting of a plurality of reaction tubes, wherein the tube sections within the reactor vessel are arranged in a fluidically unconnected manner and at least partially side by side and in each case are connected to a feed section (for fluid) in the first region and an extraction section (for fluid) in the second region. The latter extend in particular in the same direction as the tube sections or do not cause any fluid flow deflected by more than 15° in relation to the fluid flow in the tube sections connected thereto. The feed sections and extraction sections are in particular likewise formed integrally with these, i.e. in particular in the form of the same tube. The reaction tubes are designed here in particular without U-bends. In this way, a reactor is created, as is suitable, for example, in particular for carrying out steam reforming. This can also be effected in particular by equipping the reaction tubes with a suitable catalyst. In this embodiment, the connecting element in the second region is cast, in particular, onto the reaction tubes. In particular, it can surround the reaction tubes in the manner of a cuff.

In all of the cases explained above, the connecting element and the tube sections can be formed from the same material or from materials whose electrical conductivities (in the sense of a material constant, as is customary in the field) differ by no more than 50%, no more than 30%, no more than 10%, or are advantageously the same. For example, the connecting element and the tube sections can also be formed from steels of the same steel class. The use of identical or closely related materials can facilitate the one-piece design of the connecting element and of the tube sections, for example by means of casting or welding.

In all cases, by forming the connecting element from as few individual parts as possible, the number of metal-to-metal connections (e.g., welded or soldered connections) can be reduced or even completely dispensed with. Mechanical stability and reliability can thereby be increased. In a further embodiment, the connecting element can be implemented as a single casting, or, as mentioned, parts of the process-carrying pipes can be cast into the connecting element and/or parts of the process-carrying pipes can be formed as an integral component of a corresponding casting.

Metal-to-metal connections or metal transitions, which can be reduced within the scope of the disclosed embodiments, could lead to a local change in electrical resistance, and therefore to hot spots. Hot spots in turn lead to a reduction in service life due to elevated local temperatures or to mechanical stress peaks due to steep local temperature gradients. This is avoided within the scope of the disclosed embodiments.

A one-piece connecting element provides mechanical stability, reliability and a reduction in individual components. A high mechanical stability of the star bridge is desirable since, as mentioned, failure of the star bridge will lead to safety-critical situations. By means of the described embodiment in the sense of the disclosed embodiments, the principle of reaction tubes resistively heated with polyphase alternating current in a star circuit is technically realizable in the high-temperature range, i.e. in particular at more than 500° C., more than 600° C., more than 700° C. or more than 800° C.

A desired increased conductance of the connecting element can be achieved in the case of equal conductivities by an increase in the cross-sectional area according to R=ρ (l/A), where R is the resistance of the conductor in ohms, ρ is the specific electrical resistance, i.e. the reciprocal of the conductivity, l is the length of the conductor and A is its cross-sectional area.

Possible materials for the reaction tubes and therefore also for the connecting element are, for example, highly alloyed chrome-nickel steels, such as are also used in fired furnaces. Advantageously, these are alloys with high oxidation or scale resistance and high carburizing resistance.

For example, it may be an alloy with 0.1 to 0.5 wt % carbon, 20 to 50 wt % chromium, 20 to 80 wt % nickel, 0 to 2 wt % niobium, 0 to 3 wt % silicon, 0 to 5 wt % tungsten and 0 to 1 wt % other components, wherein the constituents complement each other to form the non-ferrous fraction. A corresponding alloy may also, for example, contain 20 to 40 wt % chromium, to 50 wt % nickel, 0 to 10 wt % silicon, 0 to 10 wt % aluminum and 0 to 4 wt % niobium.

For example, materials with the standard designations GX40CrNiSi25-20, GX40NiCrSiNb35-25, GX45NiCrSiNbTi35-25, GX35CrNiSiNb24-24, GX45NiCrSi35-25, GX43NiCrWSi35-25-4, GX10NiCrNb32-20, GX50CrNiSi30-30, G-NiCr28 W, G-NiCrCoW, GX45NiCrSiNb45-35, GX13NiCrNb45-35, GX13NiCrNb37-25, or GX55NiCrWZr33-30-04, according to DIN EN 10027 Part 1, “Materials”, may be used. These have proven to be particularly suitable for high-temperature use.

In a further embodiment, the connecting element can be thermally insulated from the hot environment in order to reduce thermal stress resulting from steep temperature gradients. For example, a radiation protection shield arranged within the reactor vessel can be provided, which shields the region of the connecting element from an excessive heat input from the region of the tube sections.

In a further embodiment, a part of the connecting element may consist of the material of the reaction tubes and a part (or further parts) of the connecting element may consist of a material having a higher specific electrical conductivity. In this case, a solid metal-to-metal connection (e.g., a weld seam) is not necessarily provided. The electrical contact can also be ensured by a different thermal expansion. For example, a casting consisting of one of the previously specified materials could be inserted into a matching molybdenum U-profile.

In this development, therefore, in the language of the claims, the connecting element is surrounded at least in part by a conducting element made of a material rich in molybdenum, tungsten, tantalum, niobium and/or chromium or formed therefrom. In particular, the material has a higher specific electrical conductivity than the material from which the connecting element is formed. As a result, the potential equalization in the star point can be significantly improved or a corresponding connecting element can be constructed to be correspondingly lighter.

The disclosed embodiments also relate to a method for performing a chemical reaction using a reactor having a reactor vessel and one or more reaction tubes, wherein a number of tube sections of the one or more reaction tubes in each case run between a first region and a second region in the reactor vessel, and wherein the first regions for heating the tube sections are in each case electrically connected to the phase connections of a polyphase AC power source.

According to the disclosed embodiments, a reactor is used here in which the tube sections in the second regions are connected to one another in an electrically conductive manner by means of a connecting element which is integrally connected to the one or more reaction tubes and is arranged inside the reactor vessel.

For further features and advantages of a corresponding method, in which a reactor according to one of the previously explained developments of the invention is advantageously used, reference is made to the above explanations.

The disclosed embodiments will be further elucidated below with reference to the accompanying drawings, which illustrate developments of the disclosed embodiments with reference to and in comparison with the prior art.

### DESCRIPTION OF THE FIGURES

FIG. 1 schematically illustrates a reactor for carrying out a chemical reaction according to a non-inventive development.

FIG. 2 schematically illustrates a reactor for carrying out a chemical reaction according to a development of the disclosed embodiments.

FIG. 3 schematically illustrates a reactor for carrying out a chemical reaction according to a further development of the disclosed embodiments.

FIG. 4 schematically illustrates a connecting element for use in a reactor according to a development of the disclosed embodiments.

FIG. 5 schematically illustrates a connecting element for use in a reactor according to a development of the disclosed embodiments.

FIG. 6 schematically illustrates a connecting element in cross-section for use in a reactor according to a development of the disclosed embodiments.

FIG. 7 illustrates resistors in an arrangement for use in a reactor according to a development of the disclosed embodiments.

FIGS. 8A to 8C illustrate reaction tubes and corresponding arrangements for use in a reactor according to a development of the disclosed embodiments.

FIGS. 9A and 9B illustrate reaction tubes and corresponding arrangements for use in a reactor according to a development of the disclosed embodiments.

FIGS. 10A to 10C illustrate further reaction tubes for use in a reactor according to a development of the disclosed embodiments.

In the following figures, elements that correspond to one another functionally or structurally are indicated by identical reference symbols and for the sake of clarity are not repeatedly explained. If components of devices are explained below, the corresponding explanations will in each case also relate to the methods carried out therewith and vice versa.

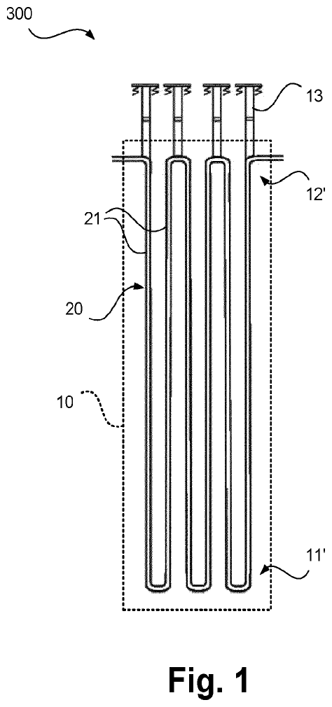

FIG. 1 schematically illustrates a reactor for carrying out a chemical reaction according to a non-inventive development.

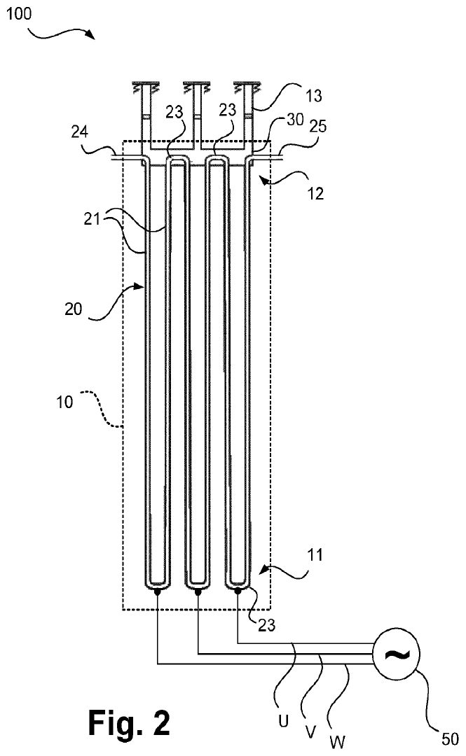

The reactor here designated 300 is set up to carry out a chemical reaction. For this purpose, it has in particular a thermally insulated reactor vessel 10 and a reaction tube 20, wherein a number of tube sections of the reaction tube 20, which are designated here by 21 only in two cases, run respectively between a first zone 11′ and a second zone 12′ in the reactor vessel 10. The reaction tube 20, which will be explained in more detail below with reference to FIG. 2, is attached to a ceiling of the reactor vessel or to a support structure by means of suitable suspensions 13. In a lower region, the reactor vessel can in particular have a furnace (not illustrated). It goes without saying that a plurality of reaction tubes can be provided in each case here and subsequently.

FIG. 2 schematically illustrates a reactor for carrying out a chemical reaction according to a development of the disclosed embodiments, which are overall denoted by 100.

The zones previously designated 11′ and 12′ here take the form of regions 11 and 12, wherein the tube sections 21 for heating the tube sections 21 in the first regions 11 can in each case be electrically connected to the phase connections U, V, W of a polyphase alternating current source 50. Corresponding phase connections can also be designated according to convention as L1, L2, L3 or A, B, C as well as other abbreviations. Switches and the like as well as the specific type of connection are not illustrated.

In the development of the disclosed embodiments illustrated here, the tube sections 21 are electrically conductively connected to one another in the second regions 12 by means of a connecting element 30 which is integrally connected to the one or more reaction tubes 20 and is arranged within the reactor vessel 10. A neutral conductor may also be connected thereto.

In the reactor 100 illustrated here, a plurality of tube sections 21 of a reaction tube 20 (although a plurality of such reaction tubes 20 may be provided) are thus arranged side by side in the reactor vessel 10. The tube sections 21 pass into one another via U-bends 23 (only partially denoted) and are connected to a feed section 24 and an extraction section 25.

A first group of the U-bends 23 (at the bottom in the drawing) is arranged side by side in the first region 11 and a second group of the U-bends 23 (at the top in the drawing) is arranged side by side in the second region 12. The U-bends 23 of the second group are formed in the connecting element 30, and the tube sections 21 extend from the connecting element 30 in the second region 12 to the first region 11.

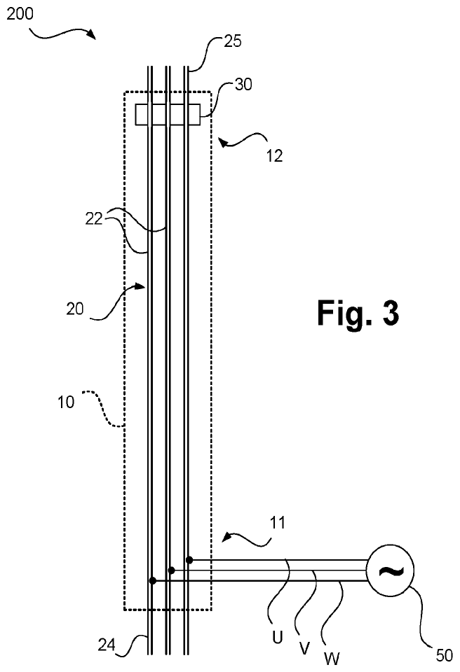

FIG. 3 schematically illustrates a reactor, which is overall denoted by 200, for carrying out a chemical reaction according to a development of the disclosed embodiments.

In the reactor 200, the tube sections—here in contrast denoted by 22—in each case comprise a tube section 22 consisting of a plurality of reaction tubes 20, wherein the tube sections 22 are arranged side by side in the reactor vessel 10 in a fluidically unconnected manner and are in each case connected to feed sections 24 and extraction sections 25. For the remaining elements, reference is expressly made to the above explanations relating to the preceding figures.

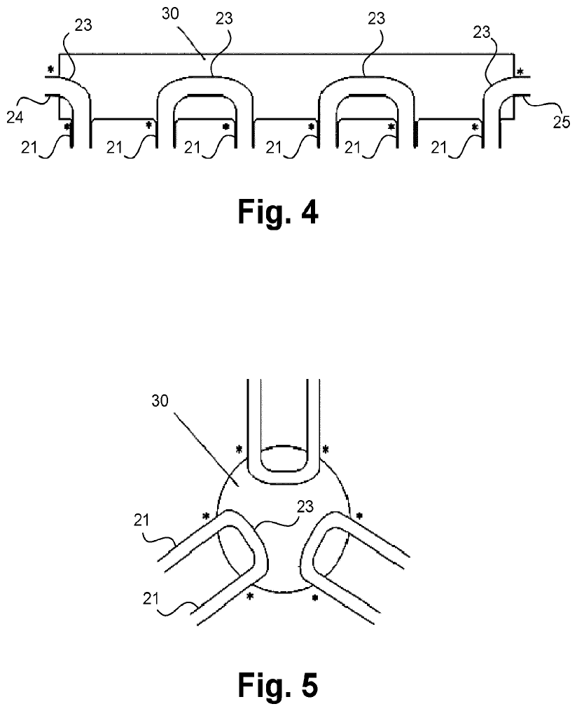

FIG. 4 schematically illustrates a connecting element 30 for use in a reactor according to a development of the disclosed embodiments, for example in the reactor 100 according to FIG. 2.

Since the elements illustrated in the figure have essentially already been explained above, reference is expressly made to the above explanations, in particular to FIGS. 1 and 2. Not shown here are the suspensions 13, illustrated additionally in the form of asterisk symbols, onto which, in the development illustrated here, the tube sections 21 and the U-bends 23 formed in the connecting element 30 for example during casting, are welded.

FIG. 5 schematically illustrates a connecting element 30 for use in a reactor, according to a development of the disclosed embodiments, such as has not been previously illustrated.

As shown here, within the scope of the disclosed embodiments, a star-shaped (in the geometric sense) arrangement of the tube sections 21 can also be made, the connecting element 30 being at the center of this arrangement. It goes without saying that a plurality of such star-shaped arrangements can also be provided, for example, side by side or stacked on top of each other. Unlike the arrangement as illustrated in FIG. 5, the tube sections may also extend upwardly or downwardly, for example, from the drawing plane.

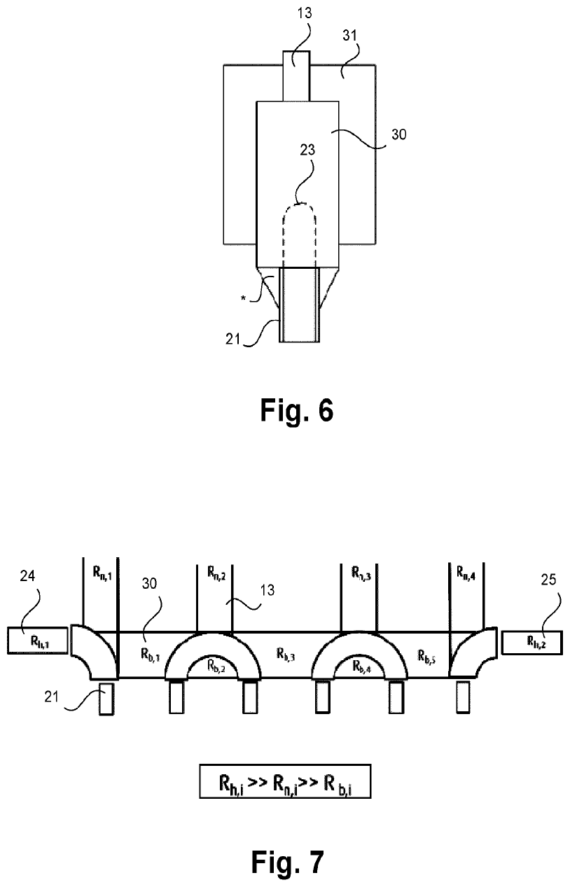

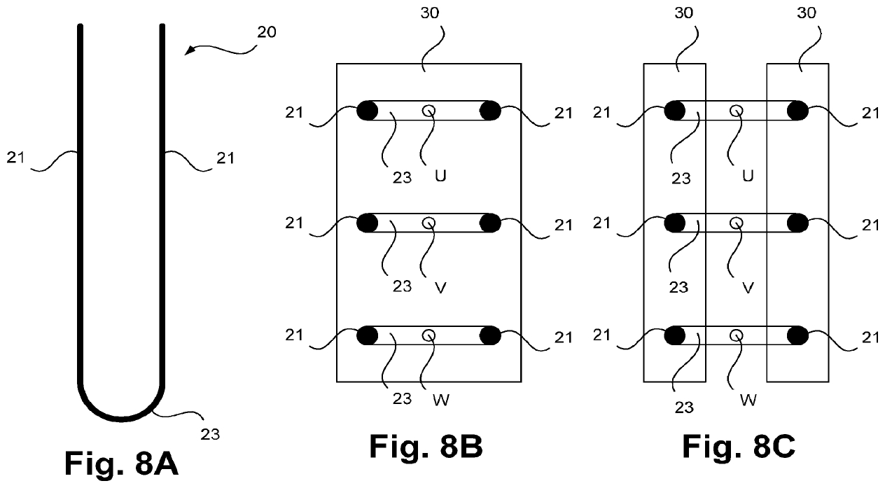

FIG. 6 schematically illustrates a connecting element 30 in cross-section for use in a reactor according to a development of the disclosed embodiments, once again, for example, in the reactor 100 according to FIG. 2.

As illustrated here, the connecting element 30 is surrounded at least in part by a conducting element 31 made of a previously explained material with suitable conductivity and which, for example, takes the form of a U-profile. The connecting element 30 can be formed, for example, from a high-alloy chrome-nickel steel, for example from the ET45 micro-material mentioned. The conducting element 31 improves the potential equalization, as already explained.

FIG. 7 illustrates resistors in an arrangement for use in a reactor according to a development of the disclosed embodiments or, here, advantageously to achieve resistance relationships of the elements with respect to one another. The arrangement is particularly suitable for use in a reactor 100 according to FIG. 2.

Resistors in the connecting element 30 are indicated in FIG. 7 by Rb, i, in the feed and extraction sections 24 and 25 by Rh, i, and in the suspensions 13 by Rn, i. As also shown in FIG. 7 itself, Rh,i>>Rn,i>>Rb,i should advantageously apply.

In cracker furnaces, in addition to the reaction tubes 20 previously shown in FIGS. 1 and 2, which are commonly referred to as 6-passage coils, and the six straight tube sections 21 having two 180° bends, i.e., U-bends 23, above or in the second region 12, and three 180° bends, i.e., U-bends 23, below or in the first region 11, variants with fewer passages can also be used. For example, so-called 2-passage coils have only two straight tube sections 21 and only one 180° bend or U-bend 23. Transferred to electrical heating, this variant can be regarded as a combination of 6-passage cracker furnaces (FIGS. 1 and 2) and reforming furnaces (FIG. 3, with reaction tubes without U-bends 23):

The flow can be fed in at one point per reaction tube 21 at the lower (or only) U-bend. In each case, M reaction tubes can be electrically coupled to one another, with a phase shift of 360°/M and with a common connecting element 30. In a first alternative, a particularly large connecting element 30 can be used per coil package or for all reaction tubes 20 considered in each case. In a second alternative, however, the use of two smaller-sized connecting elements 30 is also possible.

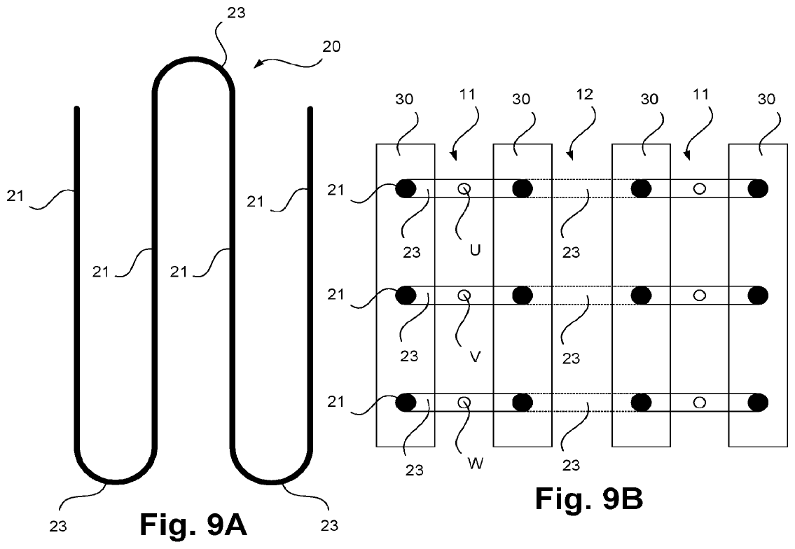

The first alternative just explained is illustrated in FIG. 9B, the second alternative just explained in FIG. 9C in a cross-sectional view through the tube sections 21, wherein a corresponding reaction tube 20 is shown in FIG. 9A in a view perpendicular to the views in FIGS. 9B and 9C. Reference is made to FIG. 1 for the designation of the corresponding elements. It goes without saying that the connecting element or elements 30 with the U-bends 23 possibly arranged there on the one hand and the other U-bends 23 on the other hand with the connections to the phases U, V, W are arranged in different planes corresponding to the first and second regions 11, 12 of a reactor.

This concept can also be applied correspondingly to coils or reaction tubes 20 having four passages or tube sections 21 (so-called 4-passage coils), in this case with one, two or four star bridges or connecting elements 30. A corresponding example is shown in FIGS. 9A and 9B, four connecting elements being shown in FIG. 9B. For improved illustration, the U-bends 23 are shown here by dashed lines (U-bends in the second region 12 of the reactor) and by unbroken lines (U-bends in the first region 11). For the sake of clarity, the elements are only partially provided with reference numerals.

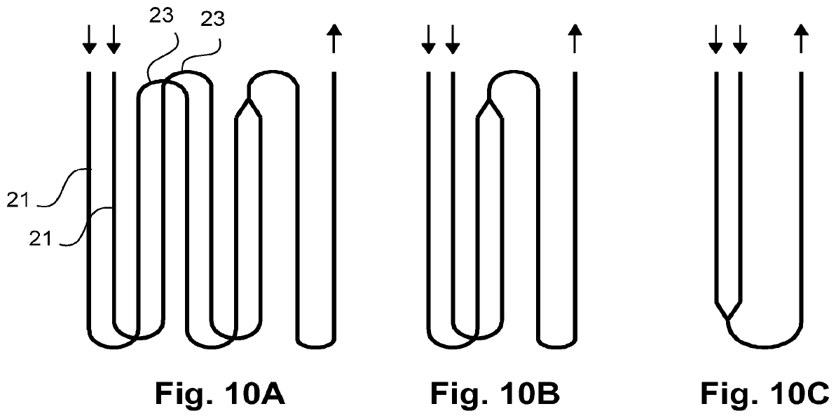

Reference has already been made to FIGS. 10A and 10B, which illustrate further reaction tubes for use in a reactor according to a development of the disclosed embodiments. The reaction tubes and tube sections are here only in some cases provided with reference numerals. Feed and extraction sections may be deduced from the flow arrows shown.

1. A reactor for carrying out a chemical reaction, the reactor comprising:
a reactor vessel and one or more reaction tubes, wherein a number of tube sections of the one or more reaction tubes run between a first region for electrical heating and a second region within the reactor vessel, and wherein the tube sections in the first region electrically connected to the phase connections of a polyphase alternating current source, and used as electrical resistors in order to generate heat and; the tube sections in the second region are either: (i) electrically conductively connected to one another as a whole by means of a single rigid connecting element or in groups by means of a plurality of rigid connecting elements, which are integrally connected to the one or more reaction tubes; or (ii) are arranged within the reactor vessel as one or more star bridges effecting a potential equalization, wherein the one or more connecting elements is or are configured for operation at a temperature of more than 700° C.

2. A reactor according to claim 1, wherein the chemical reaction is an endothermic chemical reaction.

3. A reactor according to claim 1, wherein each of the tube sections comprise two tube sections of a plurality of reaction tubes which are arranged at least partially side by side in the reactor vessel, wherein the respective two tube sections of the plurality of reaction tubes pass into one another in the first region in each case via a U-bend.

4. A reactor according to claim 3, wherein one tube section of each of the two tube sections of the plurality of reaction tubes is connected to a first of the plurality of connecting elements and the other tube section of the respective two tube sections of the plurality of reaction tubes is connected to a second of the plurality of connecting elements.

5. A reactor according to claim 3, wherein both tube sections of the plurality of reaction tubes are connected to the one connecting element.

6. A reactor according to claim 1, in which the tube sections are an even number of four or more tube sections of a reaction tube or one of a plurality of reaction tubes serially connected to one another via a number of U-bends, wherein the number of U-bends is one less than the number of tube sections serially connected to one another via the U-bends, and wherein the U-bends, beginning with a first U-bend in the first region, are arranged alternately in the first region and in the second region.

7. A reactor according to claim 6, in which the U-bend or U-bends arranged in the second region is or are formed in the rigid connecting element and in which the tube sections extend from the connecting element the second region to the first region.

8. A reactor according to claim 6, in which the connecting element is cast onto the formed tube sections previously provided with the U-bend or U-bends in the second region or connected thereto.

9. A reactor according to claim 6, wherein the U-bend or U-bends in the second region are formed in the connecting element and the tube sections are welded to the connecting element.

10. A reactor according to claim 1, which is designed as a reactor for steam cracking.

11. A reactor according to claim 1, wherein the tube sections in each case comprise a tube section of a plurality of reaction tubes, wherein the tube sections are arranged side by side in the reactor vessel in a fluidically unconnected manner and are in each case connected to a feed section in the first region and an extraction section in the second region.

12. A reactor according to claim 11, which is designed as a reactor for steam reforming, dry reforming or the catalytic dehydrogenation of alkanes.

13. A reactor according to claim 1, wherein the connecting element and the tube sections are formed from the same material or from materials whose electrical conductivities differ from one another by not more than 50%.

14. A reactor according to claim 1, wherein the connecting element and the tube sections are formed from the same material or from materials whose electrical conductivities differ from one another by not more than 30%.

15. A reactor according to claim 1 wherein the connecting element and the tube sections are formed from the same material or from materials whose electrical conductivities differ from one another by not more than 10%.

16. A reactor according to claim 1 wherein the connecting element and the tube sections are formed from chrome-nickel steels which comprise 0.1 to 0.5 wt % carbon, 20 to 50 wt % chromium, 20 to 80 wt % nickel, 0 to 2 wt % niobium, 0 to 3 wt % silicon, 0 to 5 wt % tungsten and 0 to 1 wt % other constituents, preferably 20 to 40 wt % chromium, 20 to 50 wt % nickel, 0 to 10 wt % silicon, 0 to 10 wt % aluminum and 0 to 4 wt % niobium, wherein the contents of the specified constituents in each case complement one another to form the non-ferrous fraction.

17. A reactor according to claim 1, wherein the connecting element is surrounded at least in part by a conducting element made of a material rich in molybdenum, tungsten, tantalum, niobium and/or chromium or formed therefrom and/or which has a higher specific electrical conductivity than the material from which the connecting element is formed.

18. A method for carrying out a chemical reaction using a reactor, which has a reactor vessel and one or more reaction tubes, wherein a number of tube sections of the one or more reaction tubes in each case run between a first region and a second region within the reactor vessel, and wherein the tube sections in the first region for the heating of the tube sections in each case are electrically connected to the phase connections of a polyphase alternating current source, the tube sections as electrical resistors in order to generate heat; electrically conductively connecting the tube sections in the second region to one another as a whole by means of a single rigid connecting element or in groups by means of a plurality of rigid connecting elements, which are integrally connected to the one or more reaction tubes and are arranged within the reactor vessel as one or more star bridges effecting a potential equalization; and operating the one or more connecting elements at a temperature of more than 700° C.
